(19) United States
(12) Patent Application Publication
(10) Pub. No.: US 2008/0309290 A1
(43) Pub. Date: Dec. 18, 2008

(54) Portable electric power station

(76) Inventor: Anthony Johnson, Laurel, DE (US)

Correspondence Address: HOLLSTEIN KEATING CATTELL JOHNSON & GOLDSTEIN P.C., WILLOW RIDGE EXECUTIVE OFFICE PARK, 750 ROUTE 73 SOUTH, SUITE 301, MARLTON, NJ, 08053, US

(21) Appl. No.: 11/818,823

(22) Filed: Jun. 15, 2007

(51) Int. Cl. H02J 7/14; H02K 53/00

(52) U.S. Cl. 320/137; 74/DIG. 9

(57) ABSTRACT

A portable, electrical power station has an insulated, wheeled housing containing a self-contained, self-sustaining electrical power generating system. The system employs a key operated ignition switch which activates an inverter. The inverter converts direct current received from a battery to alternating current and sends that current to a motor which then powers an alternator. The alternator generates electric current to the inverter. Electricity is contemporaneously sent from the inverter to electrical outlets located on an outer wall of the housing. An unlimited variety of electrical devices and appliances can then be powered by simply plugging into the outlets.

### BACKGROUND OF THE INVENTION

The uninterrupted flow of electrical energy for everyday use is something which is not only relied upon, but is taken for granted. However, the value of a constant flow of electricity is truly appreciated when electrical power is cut-off, either intentionally for repairs, upgrading systems etc., or suddenly and without warning due to power outages, blackouts, natural disasters such as hurricanes, lightning storms, or other unforeseen, emergent circumstances. In these situations and also when there is no outside source of electricity, e.g. during a camping or fishing trip, on the beach, or other remote location, it would be of extreme benefit to have a ready, powerful, long-lasting source of electricity which could be available for immediate use.

While there are numerous portable, electrical energy devices available, virtually all of these rely on a battery as the source of electricity either to jump start a car's electrical system or to supply limited electrical power for external usage. Such devices most often do not have a long worklife and they also fail to produce sufficient electricity to power electrical devices or to power them for any meaningful length of time.

### SUMMARY OF THE INVENTION

It is thus the object of the present invention to overcome the limitations and disadvantages of prior portable electrical energy devices.

It is the object of the present invention to provide a portable electric power station which is available to supply a ready and available source of electricity to power lamps, heaters, computers, televisions, radios and other electrical appliances.

It is another object of the present invention to provide a portable electric power station which is available to supply a ready and available source of electricity during power outages, blackouts, hurricanes, lightning storms or other unforeseen, emergent circumstances, as well as for recreational and general business use.

It is still another object of the present invention to provide a portable electric power station which is easy and quick to activate for immediate use.

It is another object of the present invention to provide a portable electric power station which is easily transportable for use in any environment.

It is a further object of the present invention to provide a portable electric power station which emits limited noise, produces no noxious fumes, and is safe for use in the home or office, as well as outdoors.

These and other objects are accomplished by the present invention, a portable, electrical power station which comprises an insulated, wheeled housing containing a self-contained, self-sustaining electrical power generating system. The system employs a key operated ignition switch which activates an inverter. The inverter converts direct current received from a battery to alternating current and sends that current to a motor which then powers an alternator. The alternator generates electric current to the inverter. Electricity is contemporaneously sent from the inverter to electrical outlets located on an outer wall of the housing. An unlimited variety of electrical devices and appliances can then be powered by simply plugging into the outlets.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an isometric rear view of the present invention.

FIG. 2 is an isometric front view of the present invention.

FIG. 3 is an elevation view of the present invention with a side wall removed.

FIG. 4 is a schematic representation showing the electrical circuitry and components of the present invention.

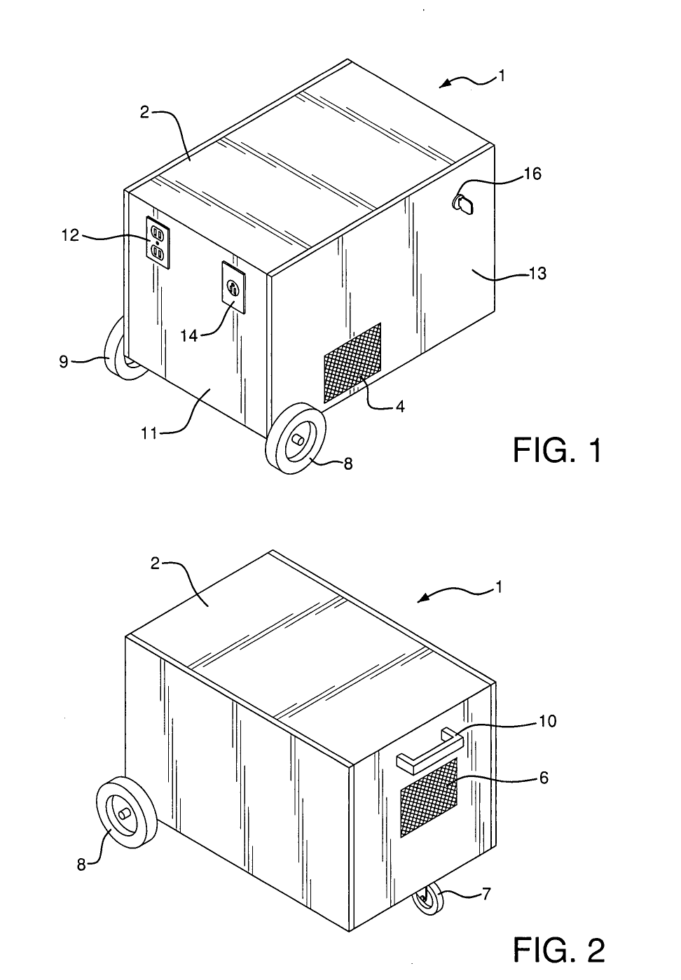

### DETAILED DESCRIPTION OF THE INVENTION

Portable electrical power station 1 of the present invention comprises portable, easily moveable housing 2, shown as being a rectangular box shape. The invention however, should not be considered restricted to the shape or configuration of the housing. Housing 2 has vent openings 4 and 6 for permitting venting of heat build-up internally of the housing, and wheels 7, 8, and 9 and manual handle 10 for ready transporting the housing. Electrical outlets 12 and 14 are positioned on rear outside wall 11 of housing 2. Key ignition switch 16 is positioned on side outside wall 13. Internal insulation 17 is provided along interior surfaces of housing 2 to muffle sound generated by station 1. Housing 2 itself will be made of lightweight material, to make transporting station 1 easy.

Located in space 19 within housing 2 is the self-contained electrical power generating system 20 of the invention. System 20 comprises direct electrical current battery 22, inverter 24 for converting direct current to alternating current, electrical matter 26 for powering rotatable belt 28, which in turn operates electrical alternator 30, which generates alternating current.

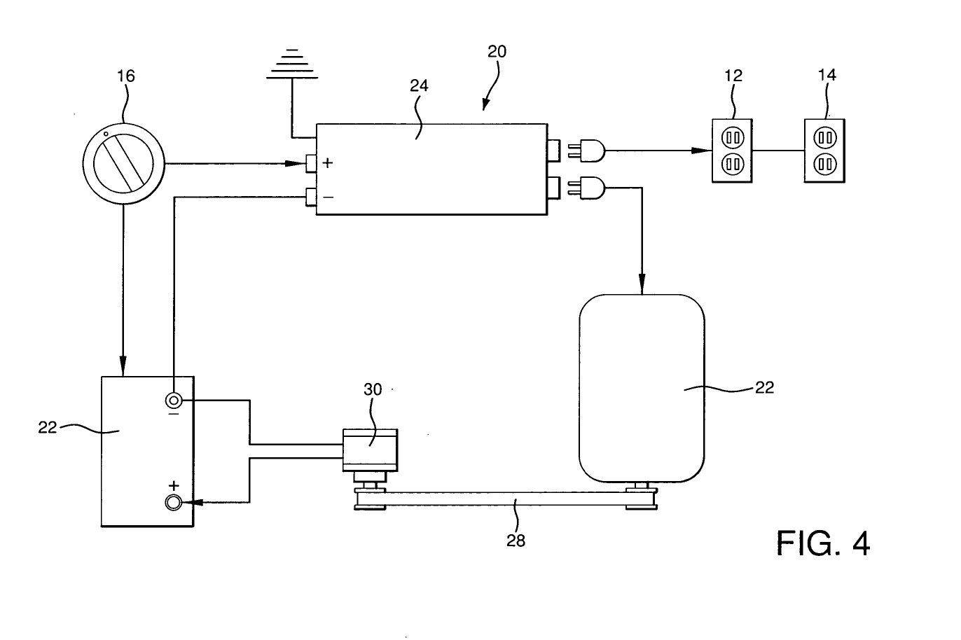

The circuitry and relation of the components can easily be seen in FIG. 4. There is a wired connection between ignition switch 16 and inverter 24 and between the ignition switch and battery 22. Battery 22 is connected to inverter 24 at its negative terminal and at its positive terminal to alternator 30. Inverter 24 provides alternating electrical current directly to motor 22 and to outlet 12, connected in series to outlet 14.

Activation of key operated ignition switch 16 starts inverter 24 and the inverter, having converted DC current received from battery 22 to AC current, sends that current to motor 26. Motor 26 powers rotatable belt 28 which then turns alternator 30 which charges battery 22. Once operating, alternator 30 begins generating electric current to inverter 24. Electrical power is contemporaneously sent from inverter 24 to 120 watt outlets 12 and 14. Outlets 12 and 14 are then available to power any lamp, heater, television, radio, computer, or other electrical appliance.

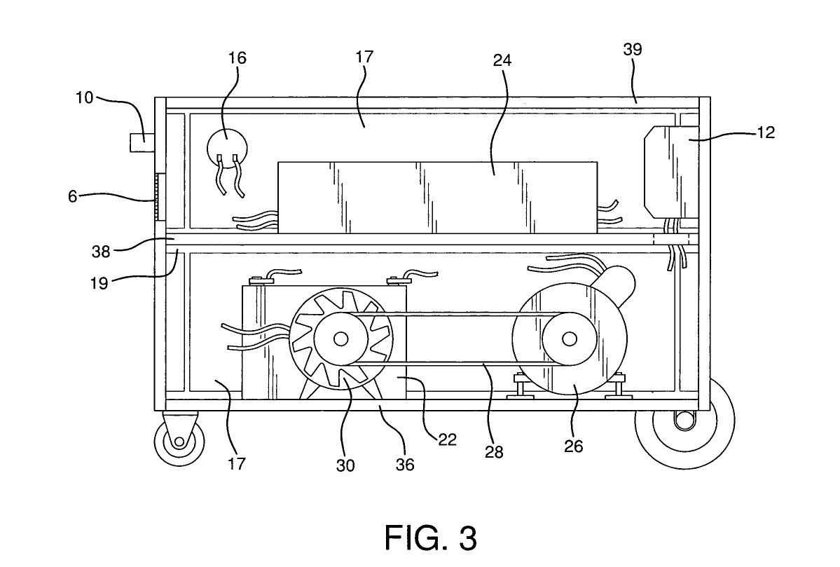

In the configuration shown in FIG. 3, battery 22, alternator 30, and motor 26 are positioned within and on bottom base 36 of housing 2. Inverter 24 is located above these components on shelf 38. Top 39 of housing 2 is configured to be removeable to allow easy access to inverter 24; and shelf 38 can also be removeable to gain access to the components located on bottom base 36. Once again, the invention is not to be considered restricted to placement or configuration of the components in electrical power generating system 20 within housing 2. Equivalent, convenient, practical component configuration is contemplated.

It has been found that electrical power generating station 20 operates efficiently and effectively with a 12 volt battery 22 or, optimally, two connected 12 volt batteries, a 2500 or 5000 watt inverter 24, a 6 amp motor 26, and a 105 volt alternator 30. However, it is also anticipated that components employing different electrical outputs can be substituted.

Electrical power station 1 is started easily and quickly by simply turning key ignition 16. It is relatively quiet and does not require any gasoline or other fuel and emits no harmful fumes or gases.

The portable nature of electrical power station 1 allows it to be employed in many different environments including, but not limited to forests, beaches, open fields, or any remote location in which there is no available source of electricity. Power station 1 is especially valuable for use in emergency situations like power outages or during natural disasters. Once power station 1 with 2500 watt inverter 24 is activated, an unlimited variety of electrical devices can be plugged into outlets 12 and 14, e.g. lamps, radios, and televisions. When 5000 watt inverter 24 is used, it can supply electricity to power computers and other electrical appliances.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A portable electric power station comprising:
a portable, enclosed housing with outside walls and an interior space in which a self-contained electrical power generating system is located, said system comprising:
ignition means for activating the system;
battery means for supplying direct current to the system;
current inverter means for converting direct current into alternating current;
alternator means for generating alternating electric current;
electric motor means for providing power to drive the alternator means; and
electric outlet means connected to the inverter means, whereby when the ignition means is activated, alternating current is produced through the inverter means, providing a source of alternating current to the outlet means for supplying electricity to outside appliances.

2. The portable electric power station as in claim 1 wherein the ignition means is key actuated from outside the housing.

3. The portable electric power station as in claim 1 further comprising a belt rotatable between the electric motor means and the alternator means, whereby the power from the motor means rotates the belt to drive the alternator means.

4. The portable electric power station as in claim 1 wherein the ignition means is electrically connected directly to the battery means and the inverter means.

5. The portable electric power station as in claim 1 wherein the inverter means provides alternating current directly to the motor means.

6. The portable electric power station as in claim 1 wherein the outlet means comprises a plurality of electrical sockets extending from an outside wall of the housing.

7. The portable electric power station as in claim 1 wherein the housing further comprises a manual handle and wheel means for transporting the power station.

8. The portable electric power station as in claim 1 wherein the housing further comprises vents located within outside walls of the housing.
